(19) United States
(12) Patent Application Publication
(10) Pub. No.: US 2014/0062231 A1
(43) Pub. Date: Mar. 6, 2014

(54) WIND TURBINE

(71) Applicants: Matteo Casazza, Val Di Vizze (IT); Otto Pabst, Rio Di Pusteria (IT); Alessandro Fasolo, Vipiteno (IT)

(72) Inventors: Matteo Casazza, Val Di Vizze (IT); Otto Pabst, Rio Di Pusteria (IT); Alessandro Fasolo, Vipiteno (IT)

(73) Assignee: WILIC S.AR.L, Luxembourg (LU)

(21) Appl. No.: 14/003,739

(22) PCT Filed: Mar. 10, 2012
(86) PCT No.: PCT/IB2012/051133

§ 371 Date: Nov. 11, 2013

(30) Foreign Application Priority Data
Mar. 10, 2011 (IT) M12011A000374

(51) Int. Cl. H02K 1/27; H02K 1/30; H02K 9/02

(52) U.S. Cl. CPC H02K 1/274; H02K 9/02; H02K 1/30
USPC 310/59; 310/156.49

(57) ABSTRACT

A wind turbine having an electric machine, in turn having a stator, and a rotor which rotates about an axis of rotation with respect to the stator; the rotor having a plurality of magnetized modules, and a rotor cylinder which extends circumferentially, rotates about an axis of rotation, and is configured to support the plurality of magnetized modules; and wherein the rotor cylinder is made of nonmagnetic material.

### PRIORITY CLAIM

This application is a national stage application of PCT/IB2012/051133, filed on Mar. 10, 2012, which claims the benefit of and priority to Italian Patent Application No. MI2011A 000374, filed on Mar. 10, 2011, the entire contents of which are each incorporated by reference herein.

### BACKGROUND

One type of known wind turbine includes an electric machine having a stator, and a rotor which rotates with respect to the stator about an axis of rotation. In this known wind turbine, the stator comprises a stator cylinder, and stator segments arranged about the axis of rotation along the stator cylinder. And, similarly, the rotor comprises a rotor cylinder, and rotor segments arranged about the axis of rotation along the rotor cylinder. Each rotor segment comprises a support extending parallel to the axis of rotation; and magnetized modules arranged inside the support, parallel to the axis of rotation. The rotor segments are fitted to the rotor cylinder, and the stator segments to the stator cylinder. The rotor cylinder is fitted to the stator cylinder by at least one bearing, and is connected to a hub and to blades arranged about the hub.

German Patent No. DE 10 2009 025929 and PCT Patent Application No. WO 2006017377 disclose a rotor comprising magnetic guides and magnetic module and wherein the magnetic guides are fixed directly to the rotor.

European Patent No. EP 2282397 discloses a rotor comprising a magnetic guide and magnetic module supported by supports and spaced apart from rotor cylinder.

One known drawback of certain known wind turbines lies in part of the energy transmitted from the blades to the electric machine being dispersed in so-called electromagnetic losses, particularly in the rotor.

Electromagnetic losses are caused by electromagnetic fields interacting between the stator and rotor, thus resulting in power dissipation and a reduction in the efficiency of the electric machine.

One particular type of electromagnetic loss originating in the rotor is caused by the magnetic flux which closes on the rotor, is produced by the harmonics of the magnetomotive force of the stator, and induces parasitic currents in the rotor without producing any drive torque.

Another problem of certain known wind turbines lies in power dissipation overheating the component parts of the rotor.

### SUMMARY

The present disclosure relates to a wind turbine configured to produce electric power.

More specifically, the present disclosure relates to a wind turbine comprising an electric machine having a stator, and a rotor which rotates with respect to the stator about an axis of rotation.

It is an advantage of the present disclosure to provide a wind turbine configured to limit certain of the drawbacks of certain of the known art.

A further advantage of the present disclosure is to provide a wind turbine configured to reduce electromagnetic losses in the rotor caused by harmonics of the magnetomotive force of the stator.

A further advantage of the present disclosure is to provide a wind turbine configured to reduce overheating of the rotor.

According to one embodiment of the present disclosure, there is provided a wind turbine comprising an electric machine, in turn comprising a stator, and a rotor which rotates about an axis of rotation with respect to the stator; the rotor comprising a plurality of magnetized modules, and a pairs of magnetic guides coupled to at least a respective magnetized module, and a rotor cylinder which extends circumferentially, rotates about an axis of rotation, and is configured to support the plurality of magnetized modules; wherein the rotor comprises supports arranged about and extending radially with respect to the axis of rotation, and fitted to the rotor cylinder to support the magnetized modules and the pairs of magnetic guides; the pairs of magnetic guides are supported by the supports in such a way that the pairs of magnetic guides are spaced apart from the rotor cylinder; the wind turbine being characterized in that the rotor cylinder is made of nonmagnetic material.

By virtue of the present disclosure, the magnetic flux produced by the harmonics of the magnetomotive force of the stator, and which closes through the nonmagnetic rotor cylinder, is greatly attenuated with respect to certain of the known art, in which the rotor cylinder is made of ferromagnetic material. Consequently, the parasitic currents circulating in the rotor, and power dissipation are also reduced, thus reducing heating of the rotor.

In one embodiment of the present disclosure, the nonmagnetic material is aluminum, aluminum alloy, stainless steel, copper, or polymer material.

An aluminum rotor cylinder is a good heat conductor and extremely lightweight; and an aluminum rotor can be extruded to form the rotor cylinder, cooling fins and supports simultaneously, provided the fins and supports are parallel to the rotor axis.

Additional features and advantages are described in, and will be apparent from the following Detailed Description and the figures.

### BRIEF DESCRIPTION OF THE DRAWINGS

A number of non-limiting embodiments of the present disclosure will be described by way of example with reference to the accompanying drawings, in which:

FIG. 1 shows a side view of a wind turbine;

FIG. 2 shows a schematic front view, with parts removed for clarity, of an electric machine of the FIG. 1 wind turbine;

FIG. 3 shows a larger-scale fragmentary side view, with parts removed for clarity, of the FIG. 2 electric machine; and

FIG. 4 shows a larger-scale fragmentary side view, with parts removed for clarity, of an alternative embodiment of the FIG. 2 electric machine.

### DETAILED DESCRIPTION

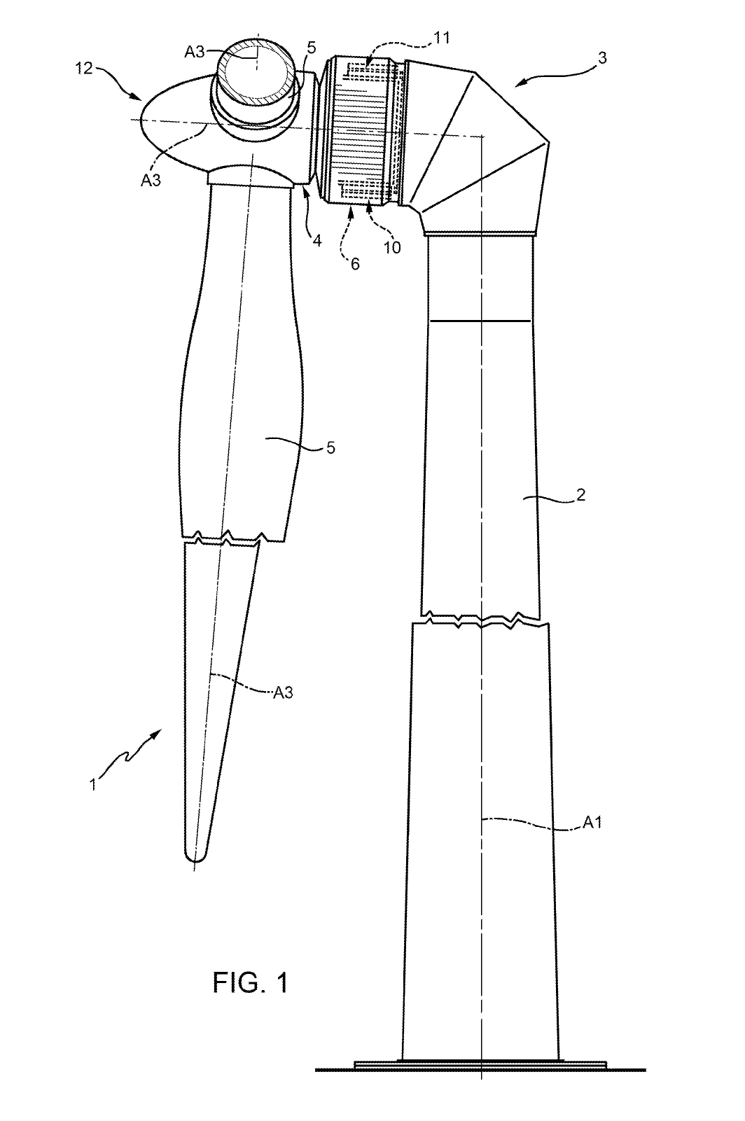

Referring now to the example embodiments of the present disclosure illustrated in FIGS. 1 to 4, number 1 in FIG. 1 indicates as a whole a wind turbine configured to produce electric power.

In the FIG. 1 example, wind turbine 1 is a direct-drive, variable-angular-speed type, and comprises a supporting structure 2, a nacelle 3, a hub 4, three blades 5 (only two shown in FIG. 1), and an electric machine 6.

Blades 5 are fitted to hub 4, in turn fitted to nacelle 3, in turn fitted to supporting structure 2.

Supporting structure 2 is a structural member supporting nacelle 3.

In another variation of the present disclosure (not shown), supporting structure 2 is a pylon, such as a pylon made of ferrous material.

As shown in FIG. 1, nacelle 3 is mounted to rotate about an axis A1 with respect to supporting structure 2, to position blades 5 into the wind; hub 4 is mounted to rotate about an axis of rotation A2 with respect to nacelle 3; and each blade 5 is fitted to hub 4 to rotate about an axis A3 with respect to hub 4. Electric machine 6 comprises a stator 10, and a rotor 11 which rotates with respect to stator 10 about axis of rotation A2. And hub 4, blades 5, and rotor 11 define a rotary assembly 12, which rotates with respect to nacelle 3 about axis of rotation A2.

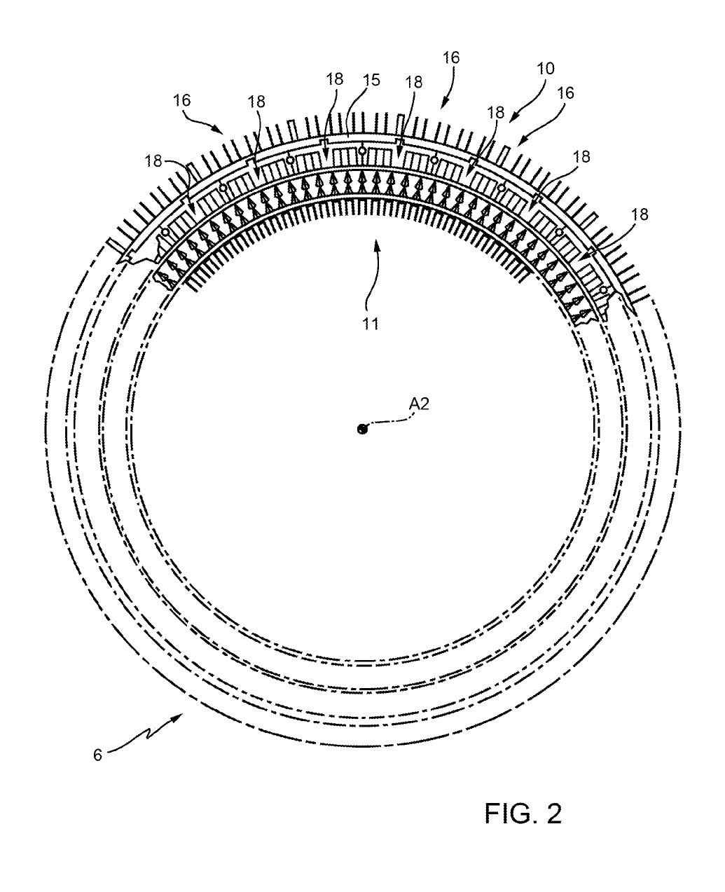

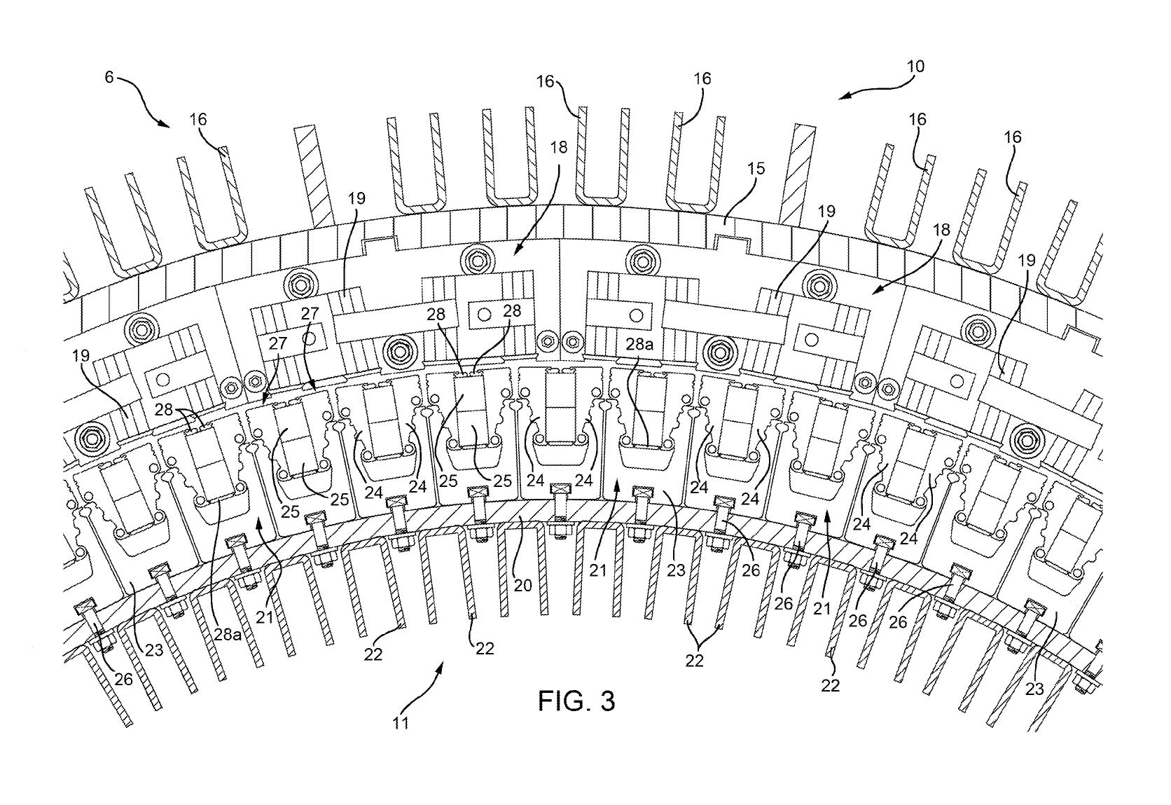

As shown in FIGS. 2 and 3, stator 10 comprises a stator cylinder 15; cooling fins 16 fixed to the outer face of stator cylinder 15; and a whole number or quantity of stator segments 18 arranged about axis of rotation A2 and fixed to the inner face of stator cylinder 15 by fastening devices (not shown). Cooling fins 16 cool stator cylinder 15 and therefore the whole of stator 10. More specifically, cooling fins 16 and stator cylinder 15 are made of heat-conducting material, so the heat produced by Joule effect and otherwise inside stator 10 is transferred to stator cylinder 15 and from this to cooling fins 16 configured to dissipate it. Each stator segment 18 comprises windings, and packs of stator laminations 19 wound with a winding associated with only one stator segment 18, so that said stator segment 18 can be removed from stator 10 without interfering with the other stator segments 18. Stator cylinder 15 covers, protects, and supports stator segments 18. Rotor 11 comprises a rotor cylinder 20; rotor segments 21 arranged about axis of rotation A2; and cooling fins 22 fixed to the inner face of rotor cylinder 20. Rotor cylinder 20 is made of nonmagnetic material and, in one embodiment of the present disclosure, is made of aluminum or aluminum alloy.

In a variation of the present disclosure, rotor cylinder 20 is made of nonmagnetic material, in particular stainless steel.

In another variation of the present disclosure, rotor cylinder 20 is made of nonmagnetic material, in particular copper.

In another variation of the present disclosure, rotor cylinder 20 is made of nonmagnetic material, in particular polymer. In one such embodiment, the nonmagnetic material includes a heat-conducting polymer material.

Cooling fins 22 cool rotor cylinder 20 and therefore the whole of rotor 11. More specifically, cooling fins 22 and rotor cylinder 20 are made of heat-conducting nonmagnetic material, so the heat produced in rotor 11 is transferred to rotor cylinder 20 and from this to cooling fins 22 configured to dissipate it.

As shown in FIG. 3, each rotor segment 21 comprises a gripper 23, magnetic guides 24, magnetized modules 25, and bolts 26.

Gripper 23 extends parallel to and radially with respect to axis of rotation A2, is fixed to rotor cylinder 20 of rotor 11 by bolts 26, is made of nonmagnetic material, and, in a non-limiting embodiment of the present disclosure, is made of aluminum or aluminum alloy.

In a variation of the present disclosure, gripper 23 is made of nonmagnetic material, in particular stainless steel.

In another variation of the present disclosure, gripper 23 is made of nonmagnetic material, in particular copper.

In another variation of the present disclosure, gripper 23 is made of a nonmagnetic material, such as a heat-conducting polymer material.

In each rotor segment 21, magnetized modules 25 are aligned radially with respect to axis of rotation A2 (FIG. 2) to form groups of modules 25, which in turn are arranged successively, parallel to axis of rotation A2 (FIG. 2), along the whole of rotor segment 21.

With particular reference to FIGS. 2 and 3, each group of modules 25 comprises two modules 25 aligned radially with respect to axis of rotation A2; and, by way of a non-limiting example, each rotor segment 21 comprises eleven groups of modules 25 (not shown in the drawings) arranged successively, parallel to axis of rotation A2.

With reference to FIGS. 2 and 3, each group of modules 25 is located between a respective pair of magnetic guides 24, each defined by respective packs of laminations made of ferromagnetic material, to guide the magnetic flux of magnetized modules 25. Each rotor segment 21 therefore comprises eleven pairs of magnetic guides 24. Each pair of magnetic guides 24 is located inside gripper 23, which is fixed to rotor cylinder 20 by bolts 26 and defines a support for the respective pair of magnetic guides 24 and the respective group of modules 25. Each pair of magnetic guides 24 has two faces 27, is traversed in use by the magnetic flux of magnetized modules 25, and defines the field lines. Group of modules 25 is protected at the top end by two insulating members 28 between magnetic guides 24, and is protected at the bottom end by an insulating member 28a between magnetic guides 24.

In electric machine 6 described above, the magnetic flux defined by the main frequency component of the magnetomotive force of stator 10 assists in defining the torque of electric machine 6 and converting kinetic to electric energy and vice versa, whereas the magnetic flux defined by the harmonics of the magnetomotive force of stator 10 plays no part in defining the torque of electric machine 6 and merely dissipates energy in heat.

By virtue of rotor cylinder 20 of nonmagnetic material, the magnetic flux defined by the harmonics of the magnetomotive force of stator 10, and which closes in nonmagnetic rotor cylinder 20, is attenuated (i.e., is not attracted to rotor cylinder 20), as in the known art, and is reduced with respect to the known art, thus reducing parasitic currents in rotor 11 and power dissipation. Moreover, reducing power dissipation also reduces the heat generated in rotor 11 with respect to the known art.

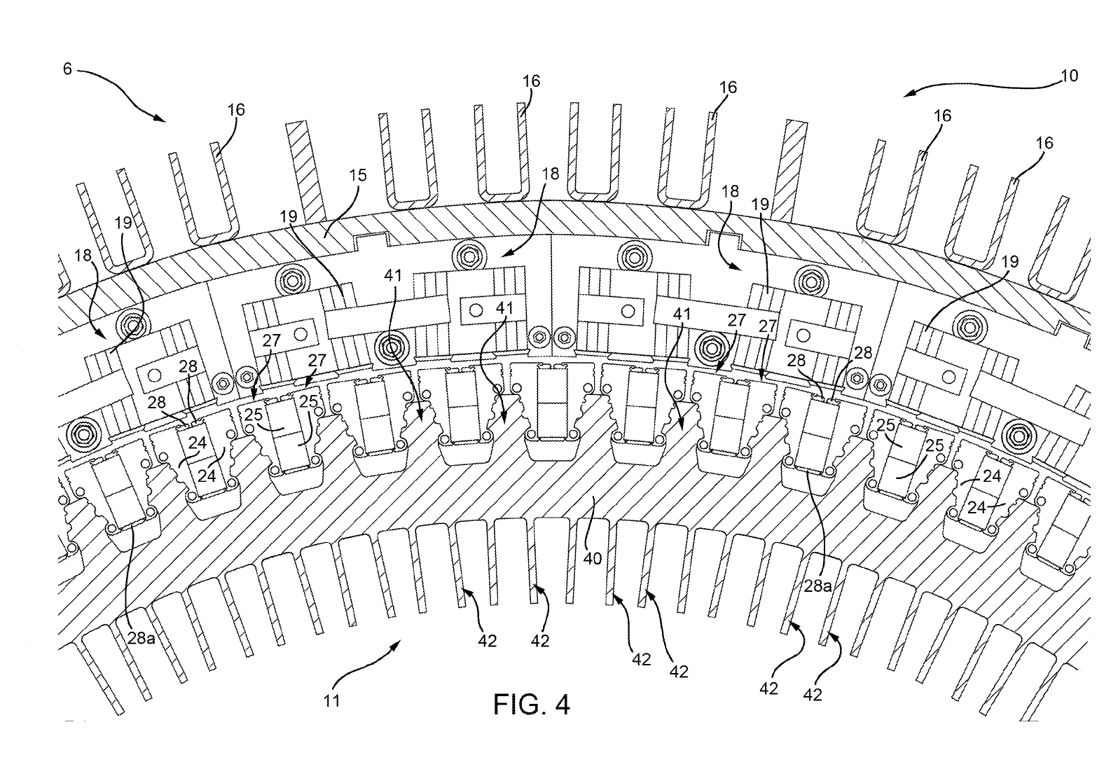

In the FIG. 4 variation of the present disclosure, rotor cylinder 20, fins 22 and grippers 23 are eliminated, and rotor 11 comprises a rotor cylinder 40, arms 41, and cooling fins 42, all made of nonmagnetic material and formed integrally in one piece.

Rotor cylinder 40 extends longitudinally, parallel to axis of rotation A2. Arms 41 extend radially, with respect to axis of rotation A2, towards stator 10, and are configured to engage magnetic guides 24, and more specifically to support magnetic guides 24 and magnetized modules 25. Arm 41 define supports for magnetized modules 25.

Cooling fins 42 extend radially, with respect to axis of rotation A2, in the opposite direction to arms 41 and towards the centre of rotor 11, and are configured to dissipate heat from rotor cylinder 40.

The nonmagnetic material from which rotor cylinder 40, arms 41 and cooling fins 42 are made is aluminum or aluminum alloy.

In a variation of the present disclosure, the nonmagnetic material from which rotor cylinder 40, arms 41 and cooling fins 42 are made is a nonmagnetic material, such as a heat-conducting polymer material.

By way of a non-limiting example, rotor 11 of aluminium, aluminium alloy or polymer material may be extruded to form rotor cylinder 40, cooling fins 42 and arms 41 simultaneously.

In a variation of the present disclosure, the nonmagnetic material from which rotor cylinder 40, arms 41 and cooling fins 42 are made is stainless steel.

In another variation of the present disclosure, the nonmagnetic material from which rotor cylinder 40, arms 41 and cooling fins 42 are made is copper-based.

Though electric machine 6 described is a radial-flux, buried permanent magnet type, the protective scope of the present disclosure extends to any other type of permanent magnet electric machine, such as radial-flux surface-magnet, or axial-flux, or cross-flux electric machines. Also, the wind turbine is a direct-drive type (i.e., in which the hub and electric machine rotor are connected directly).

The present disclosure also covers embodiments not described in the present detailed description, as well as equivalent embodiments, within the protective scope of the accompanying Claims.

That is, changes may be made to the present disclosure without, however, departing from the scope of the present disclosure as defined in the accompanying Claims. It should thus be understood that various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claims.

1-10. (canceled)

11. A wind turbine electric machine comprising:
a stator; and
a rotor configured to rotate about an axis of rotation with respect to the stator, the rotor including:
a plurality of magnetized modules,
a plurality of pairs of magnetic guides, each pair of magnetic guides coupled to at least a respective one of the magnetized modules,
a rotor cylinder made of a nonmagnetic material and which:
(i) extends circumferentially,
(ii) is configured to rotate about the axis of rotation, and
(iii) is configured to support the plurality of magnetized modules, and
a plurality of supports arranged about and extending radially with respect to the axis of rotation, said plurality of supports fitted to the rotor cylinder to:
(i) support the magnetized modules, and
(ii) support the pairs of magnetic guides such that the pairs of magnetic guides are spaced apart from the rotor cylinder.

12. The wind turbine electric machine of claim 11, wherein the rotor includes a plurality of cooling members arranged about and extending radially with respect to the axis of rotation, said plurality of cooling members fitted to the rotor cylinder and configured to cool the rotor.

13. The wind turbine electric machine of claim 12, wherein the cooling members extend from an opposite side of the rotor than the plurality of supports.

14. The wind turbine electric machine of claim 12, wherein the supports include a plurality of grippers connected to the rotor cylinder to support the plurality of magnetized modules.

15. The wind turbine electric machine of claim 12, wherein the cooling members include a plurality of cooling fins configured to cool the rotor, said cooling fins connected to the rotor cylinder on an opposite side of the rotor than the plurality of supports.

16. The wind turbine electric machine of claim 11, wherein the plurality of supports include a plurality of arms extending radially with respect to the axis of rotation to support the magnetized modules.

17. The wind turbine electric machine of claim 16, wherein the cooling members include a plurality of cooling fins configured to cool the rotor, said plurality of cooling fins extending radially with respect to the axis of rotation.

18. The wind turbine electric machine of claim 17, wherein the cooling fins extend on an opposite side of the rotor than the arms.

19. The wind turbine electric machine of claim 16, wherein the arms are made of nonmagnetic material and are coupled to the rotor cylinder.

20. The wind turbine electric machine of claim 17, wherein the cooling fins are made of nonmagnetic material and coupled to the rotor cylinder.

21. The wind turbine electric machine of claim 11, wherein the nonmagnetic material is one selected from the group consisting of: aluminum, aluminum alloy, stainless steel, copper, and a polymer material.

22. The wind turbine electric machine of claim 11, wherein the rotor includes a plurality of pairs of magnetic guides, each pair of magnetic guides being fitted to at least a respective one of the magnetized modules to guide a flux of the magnetized module.

23. A wind turbine electric machine rotor configured to rotate about an axis of rotation with respect to a stator, said wind turbine electric machine rotor comprising:
a plurality of magnetized modules;
a plurality of pairs of magnetic guides, each pair of magnetic guides coupled to at least a respective one of the magnetized modules;
a rotor cylinder made of a nonmagnetic material and which:
(i) extends circumferentially,
(ii) is configured to rotate about the axis of rotation, and
(iii) is configured to support the plurality of magnetized modules; and
a plurality of supports arranged about and extending radially with respect to the axis of rotation, said plurality of supports fitted to the rotor cylinder to:
(i) support the magnetized modules, and
(ii) support the pairs of magnetic guides such that the pairs of magnetic guides are spaced apart from the rotor cylinder.

24. The wind turbine electric machine rotor of claim 23, which includes a plurality of cooling members arranged about and extending radially with respect to the axis of rotation, said plurality of cooling members fitted to the rotor cylinder.

25. The wind turbine electric machine rotor of claim 24, wherein the cooling members extend from an opposite side than the plurality of supports.

26. The wind turbine electric machine rotor of claim 24, wherein the supports include a plurality of grippers connected to the rotor cylinder to support the plurality of magnetized modules.

27. The wind turbine electric machine rotor of claim 24, wherein the cooling members include a plurality of cooling fins connected to the rotor cylinder on an opposite side than the plurality of supports.

28. The wind turbine electric machine rotor of claim 23, wherein the plurality of supports include a plurality of arms extending radially with respect to the axis of rotation to support the magnetized modules.

29. The wind turbine electric machine rotor of claim 28, wherein the cooling members include a plurality of cooling fins extending radially with respect to the axis of rotation.

30. The wind turbine electric machine rotor of claim 29, wherein the cooling fins extend on an opposite side than the arms.

31. The wind turbine electric machine rotor of claim 28, wherein the arms are made of nonmagnetic material and are coupled to the rotor cylinder.

32. The wind turbine electric machine rotor of claim 29, wherein the cooling fins are made of nonmagnetic material and coupled to the rotor cylinder.

33. The wind turbine electric machine rotor of claim 23, wherein the nonmagnetic material is one selected from the group consisting of: aluminum, aluminum alloy, stainless steel, copper, and a polymer material.

34. The wind turbine electric machine rotor of claim 23, which includes a plurality of pairs of magnetic guides, each pair of magnetic guides being fitted to at least a respective one of the magnetized modules to guide a flux of the magnetized module.
